(19) United States
(12) Patent Application Publication
(10) Pub. No.: US 2025/0087720 A1
(43) Pub. Date: Mar. 13, 2025

(54) METHOD FOR STARTING A FUEL CELL AT LOW TEMPERATURES

(71) Applicant: Aerostack GmbH, Dettingen an der Erms (DE)

(72) Inventors: Markus SCHUDY, Dettingen an der Erms (DE); Marcus-Benedict BUNTZ, Dettingen an der Erms (DE); Christoph ZIEGLER, Dettingen an der Erms (DE)

(21) Appl. No.: 18/883,056

(22) Filed: Sep. 12, 2024

(30) Foreign Application Priority Data
Sep. 13, 2023 (DE) 102023124662.3

(51) Int. Cl. H01M 8/04014; B64D 27/355; B64D 33/08; H01M 8/04029; H01M 8/04223; H01M 8/04225

(52) U.S. Cl. CPC H01M 8/04014; B64D 27/355; B64D 33/08; H01M 8/04029; H01M 8/04225; H01M 8/04253; H01M 2250/20

(57) ABSTRACT

A method and a system for starting a fuel cell at temperatures below 0° Celsius with a two-phase cooling system are indicated, whereby the two-phase cooling system has a pump to convey a coolant present in the two-phase cooling system, whereby the coolant is present at least partially in a gas phase in the two-phase cooling system, including steps of starting the fuel cell, and activating the pump after a defined period of time, whereby the coolant is present substantially in the gas phase within the fuel cell during the defined period of time.

### TECHNICAL FIELD

The disclosure herein relates generally to the technical field of aviation. In particular, the description relates to a system for starting a fuel cell at low temperatures as well as to an associated system and to an aircraft having such a system.

### BACKGROUND

Fuel cells represent one possible solution for emission-free driving or emission-free onboard power supply (APU=Auxiliary Power Unit) of, for example, aircraft. Polymer electrolyte fuel cells (PEMFC) generate power and electricity through the electrochemical reaction of hydrogen and oxygen to form water. Heat is generated during this reaction which has to be discharged. In commercial fuel cell stacks, this is generally performed by liquid cooling. One possible alternative which offers significant weight saving potential on the drive system level or the onboard power supply level lies in replacing the liquid cooling with a two-phase cooling circuit. Here, the latent evaporation heat is used to discharge large quantities of heat from the fuel cells. The high heat transfer coefficient additionally improves the performance of the thermal management system in comparison with single-phase cooling. The two-phase cooling circuit is based on the phase transitions in the fuel cells (evaporator) and in the heat exchanger to the surroundings (condenser).

In the case of typical fuel cell systems, in particular for mobile applications, it is necessary that the system can be started even at temperatures below freezing point. During this starting scenario, the heat which is generated by the fuel cells significantly contributes to the heating of the system. This represents a challenge since the formation of ice as a result or the arising water must be brought into line with the heat generated.

### SUMMARY

It can be considered to be the object of the disclosure herein to speed up the starting process of the fuel cell at temperatures below freezing point.

This object is achieved by the subject matter and embodiments disclosed herein.

According to one aspect, a method for starting a fuel cell at temperatures below 0° Celsius with a two-phase cooling system is indicated. The two-phase cooling system has a pump for conveying a coolant present in the two-phase cooling system, whereby the coolant is present in the two-phase cooling system at least partially in a gas phase.

The method has the following steps:
starting the fuel cell,
activating the pump after a defined period of time, whereby the coolant is present substantially in the gas phase within the fuel cell during the defined period of time.

Temperatures below freezing point lead to the formation of ice in the gas ducts. For this reason, the time to reach temperatures above 0° C. is regarded as a key factor, and a reduction in the thermal mass to be heated is regarded as advantageous. In order to speed up this process in comparison with liquid cooling, the technical solution is proposed of using the two-phase state of the coolant in the fuel cell and precisely controlling the coolant pump.

The described method for starting a fuel cell at temperatures below 0° C. with a two-phase cooling system thus offers an effective method for activating and operating the fuel cell in cold surroundings. The two-phase cooling system uses a special pump to convey the coolant, the coolant being present at least partially in a gas phase.

The starting process begins with the starting of the fuel cell according to the normal methods. The pump is activated after a defined period of time which is required for the necessary activation of the fuel cell. During this defined period of time, the coolant is present substantially in the gas phase within the fuel cell.

Several advantages are achieved by this manner of proceeding. Firstly, the use of a two-phase cooling system enables an efficient discharge of heat and ensures optimum cooling of the fuel cell, even at low temperatures. Secondly, the activation of the pump after a defined period of time enables a shorter start-up time for the fuel cell with a low thermal mass before the coolant enters supercooled in order to shorten the starting time or warm-up time. If the coolant is present in the gas phase, the coolant has a lower density in comparison with the liquid phase. This lower density results in a lower thermal mass, which leads to faster heating up with the same supply of heat.

The use of this method thus offers a reliable possibility of successfully starting a fuel cell in cold temperatures and subsequently operating it. It enables efficient cooling and contributes to long-term stability and performance of the fuel cell at low temperatures. By ensuring optimal operation of the fuel cell in cold surroundings, the usability and the reliability of the system are improved.

According to one embodiment, in the case of the step of starting, 100% of the coolant is present in the gas phase in the fuel cell.

According to one embodiment, the defined period of time is 60 seconds, preferably 30 seconds, particularly preferably 20 seconds.

According to one embodiment, the coolant comprises methanol and/or ethanol. This choice of coolant has several advantages for the system.

Methanol and ethanol have a high degree of thermal conductivity, which means that they can efficiently discharge heat from the fuel cells. As a result of this, effective cooling of the components is enabled and the operating temperature of the fuel cell is kept at an optimum level.

Methanol and ethanol furthermore have low boiling points. This is advantageous because they can quickly evaporate when they flow through the coolant ducts. As a result of the evaporation, heat is absorbed from the components, which leads to effective cooling.

Methanol and ethanol furthermore have a high degree of evaporation enthalpy. As a result of this, very small mass flows can be realized in the system, as a result of which pressure loss is reduced. As a result of this, lines and pumps can have smaller dimensions than with liquid cooling, which leads to a reduced system weight.

According to one embodiment, the coolant pump operates intermittently in order to keep a thermal mass of a mass flow of the coolant in the fuel cell low.

Intermittently denotes switching on and off at specific time intervals. This operating mode serves to keep the thermal mass of the coolant in the fuel cell low.

As a result of the intermittent operation of the coolant pump, the mass flow of the coolant in the fuel cell is reduced. This means that only a limited, in particular small amount of coolant circulates in the cell, which leads to a reduced thermal mass.

The advantage of this manner of proceeding lies in the fact that a smaller mass of coolant in the fuel cell leads to a quicker reaction time and a more efficient discharge of heat. The reduction in the thermal mass furthermore contributes to the fuel cell operating more efficiently and in a more stable manner overall.

As a result of the intermittent mode of operation of the coolant pump, the energy consumption of the system can also be optimized. The pump does not have to operate continuously, but rather can be controlled as a function of the thermal requirements of the fuel cell. This leads to a more efficient use of the available energy and can improve the overall efficiency of the system.

According to one aspect, a system for starting a fuel cell at temperatures below 0° Celsius with a two-phase cooling system is configured to perform a method for starting a fuel cell at temperatures below 0° Celsius. The system has, for this purpose, at least one fuel cell, a pump, a heat exchanger and a coolant circuit. The coolant circuit is configured to cool the fuel cell by two-phase cooling. The pump is configured to be activatable after a defined period of time.

According to one embodiment, a condenser bypass is used to keep a thermal mass of a mass flow circulating through the fuel cell low.

In this embodiment, a condenser bypass is used to keep the thermal mass of a circulating mass flow to and/or from the condenser low. A condenser bypass is a device or an arrangement which makes it possible to conduct a part of the mass flow or the coolant around the condenser, instead of guiding it through the condenser. The condenser bypass thus conducts the coolant past the condenser. As a result of this, the thermal mass of the circulating coolant in the circuit is reduced and no unnecessary discharge of heat to the surroundings takes place during the starting process.

The purpose of the condenser bypass lies in reducing the quantity of coolant which circulates in the cooling circuit. As a result of part of the mass flow being conducted around the condenser, the thermal mass of the coolant which circulates in the fuel cell is reduced.

The advantage of this arrangement lies in the faster reaction time and the more efficient discharge of heat. Since less coolant circulates in the fuel cell, the operating temperatures can be reached faster. At the same time, a more uniform temperature distribution is achieved in the fuel cell, which leads to improved performance and stability of the system.

The reduction in the thermal mass as a result of the condenser bypass furthermore contributes to the fuel cell operating more efficiently overall. Less coolant means a lower energy outlay for the operation of the coolant pump, which leads to optimized energy use.

The condenser bypass can also be used to control the coolant temperature. By conducting a part of the mass flow around the condenser, the temperature of the coolant can be effectively regulated in order to maintain an optimum operating temperature of the fuel cell.

According to one aspect, an aircraft comprises such a system. The system can expressly also be used in other systems such as motor vehicles, watercraft, space travel, or other units driven with a fuel cell.

The existing system design provides in summary that the fuel cells are arranged geodetically in a higher position than the rest of the coolant system. The coolant collects in the lower half of the circuit, while the vapor phase prevails in the other parts of the coolant systems (e.g. the fuel cells). Instead of switching on the pump and pushing the liquid into the fuel cell stack, the pump is activated later. Isolation valves can additionally be used to isolate the fuel cell stack from the coolant circuit. As a result of the lower thermal capacity of the vaporous coolant in the coolant duct, the starting process of the fuel cell stack can be speeded up (smaller thermal mass in comparison with conventional liquid cooling as a result of the lower thermal capacity of the gas). The temperature of the fuel cell stack will rise quickly, and as soon as a sufficient operating temperature is reached, the isolation valves open toward the fuel cell stack and rinse it with cold coolant. A sudden drop in temperature arises as a result of this. In order to limit the drop in temperature, the pump flow rate can be controlled for a gentle starting process (ramp mode, periodic switching on/off, cyclical mode). The fuel cell stack can furthermore be heated up by exclusive liquid cooling since it has a lower heat transfer coefficient than two-phase cooling. As soon as the operating temperature is reached, the saturation temperature for the two-phase cooling can be fixed.

If the coolant circulation is limited overall to the fuel cell and the bypass and the condenser is not put into operation for the start, the thermal mass in the fuel cell is still the same, but the thermal mass of the coolant to be heated outside the fuel cell is limited/lower.

According to one embodiment, the method can furthermore be supplemented by the following method steps for reducing temperature peaks during starting, which is advantageous in particular in the case of cold material:
adjusting a saturation pressure of a coolant, via a pressure regulation module, to a first saturation pressure in such a manner that a maximum temperature of a coolant induced by boiling retardation lies below a maximum operating temperature of the fuel cell;
starting the fuel cell;
in reaction to this that the maximum temperature of the coolant induced by boiling retardation is exceeded, adjusting a saturation pressure of the coolant, via the pressure regulation module, to a second saturation pressure, wherein the second saturation pressure is higher than the first saturation pressure.

In the case of two-phase flows, the saturation temperature is dependent on the pressure. The proposed operating strategy of the further method steps thus lies in fixing the maximum temperature of the boiling retardation during the starting phase below a temperature threshold of the cell components in that the saturation pressure in the cooling system is reduced. As soon as the peak value is undershot and the boiling process is initiated, the setpoint value of the pressure regulator can be increased to the nominal operating pressure/temperature.

One advantage of these described additional method steps for reducing temperature peaks during the starting of a fuel cell with a two-phase cooling system lies in the fact that it enables effective control and regulation of the saturation pressure of the coolant.

By adjusting the saturation pressure of the coolant to a first saturation pressure which lies below the maximum operating temperature of the fuel cell, it is ensured that the effect of the boiling retardation and thus overheating are avoided via the adjusted boiling temperature. This reduces the risk of temperature peaks which can occur during the starting process.

After the start of the fuel cell, the method continuously monitors the temperature of the coolant. If the maximum temperature induced by boiling retardation is exceeded, the saturation pressure of the coolant is adjusted by using the pressure regulation module. The saturation pressure is set to a second, higher saturation pressure. As a result of this, an increased discharge of heat by the coolant is enabled, which leads to improved cooling performance and effectively controls the temperature of the fuel cell.

The advantage of this approach lies in the ability to prevent or reduce temperature peaks during the starting process in particular in the case of cold temperatures. Through timely adjustment of the saturation pressure, optimum cooling performance can be ensured without overheating as a result of boiling retardation above the intended operating temperature arising. This is beneficial to the stability and longevity of the fuel cell and enables frictionless operation of the system.

In summary, the described method enables precise control of the saturation pressure of the coolant in order to minimize temperature peaks during the starting process of a fuel cell. This leads to improved reliability, performance and life span of the fuel cell and to overall optimized operational efficiency of the fuel cell system.

Such a method for starting a fuel cell at temperatures below 0° C. and additionally for reducing temperature peaks during starting can be performed in particular with a described system for operating a fuel cell with a two-phase cooling system.

### BRIEF DESCRIPTION OF THE DRAWINGS

Example embodiments of the disclosure herein are discussed in greater detail below on the basis of the enclosed drawings. The representations are schematic and not true-to-scale. Identical reference signs relate to identical or similar elements. In the drawings:

FIG. 1 shows a flowchart of a method for starting a fuel cell at temperatures below 0° C.;

FIG. 2A shows a system for operating a fuel cell with a two-phase cooling system according to a first embodiment;

FIG. 2B shows a system for operating a fuel cell with a two-phase cooling system according to a second embodiment;

FIG. 3 shows an aircraft with a system for starting a fuel cell at temperatures below 0° C.; and

FIG. 4 shows a graphic representation of a temperature profile over time.

### DETAILED DESCRIPTION

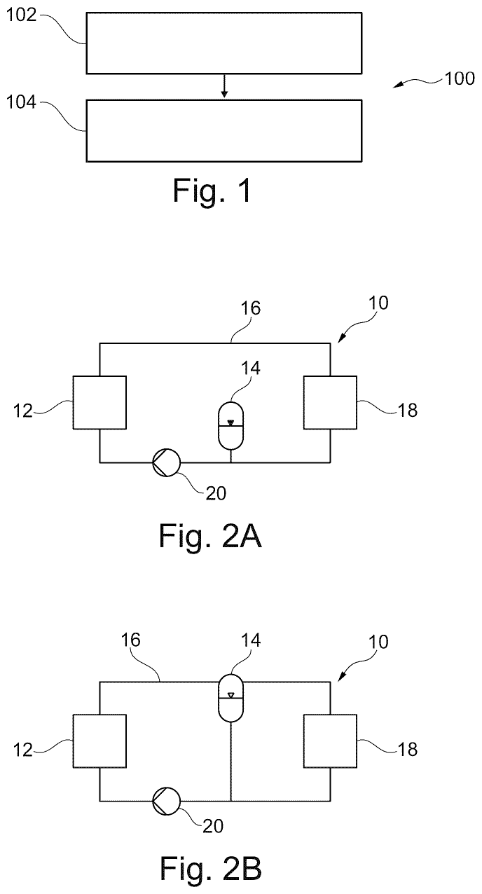

FIG. 1 shows a method 100 for starting a fuel cell at temperatures below 0° C. with a two-phase cooling system includes various steps in order to ensure a frictionless starting process. In the case of this method, a two-phase cooling system is used which contains a pump 20 in order to convey the coolant in the system 10. In this case, the coolant is located at least partially in a gas phase within the two-phase cooling system.

The first step of the method is starting 102 the fuel cell 12. In the case of temperatures below freezing point, it is particularly important that the starting process is carried out properly. Once the fuel cell has been started, the process continues to the next step.

In the next step, activation 104 of the pump 20 is performed, and indeed after a defined period of time. During this period of time, the coolant is substantially in the gas phase within the fuel cell 12. This is a decisive step in order to effectively ensure cooling. As a result of the activation of the pump, the coolant is moved through the two-phase cooling system, as a result of which the heat is discharged and the temperature of the fuel cell is stabilized.

The method makes it possible to successfully start the fuel cell even in the case of extremely low temperatures. The cooling is optimized as a result of the two-phase cooling system and the targeted activation of the pump. This helps to extend the life span of the fuel cell and increases operational reliability.

FIGS. 2A and 2B show in each case a system 10 for starting a fuel cell at temperatures below 0° C. with a two-phase cooling system which is configured to carry out the method 100 described. The system 10 is composed of several components which work together to enable a successful starting process.

The central component of the system is the fuel cell 12 which converts chemical energy into electrical energy. A two-phase cooling system is used in order to ensure effective cooling. This system uses a combination of liquid and gas phase of the coolant in order to discharge the heat and regulate the temperature of the fuel cell.

A pump 20 is present in order to move the coolant in the cooling system. This pump is designed so that it can be activated after a defined period of time. This period of time is vital to ensure that the coolant is in the correct state to ensure optimum cooling of the fuel cell.

In addition to the two-phase cooling system and the pump 20, a coolant circuit 16 and a heat exchanger 18 are integrated in the system 10. This circuit enables the continuous flow of the coolant through the fuel cell and the cooling system. It is ensured by the coolant circuit that the coolant is efficiently circulated and the discharge of heat is optimized.

The key difference between the embodiments of FIGS. 2A and 2B can be seen in the fact that the accumulator/collector 14 is connected to the return line and as a result of this the gas phase can mix with the liquid phase. In this embodiment, a condenser bypass is used to keep the thermal mass of a mass flow circulating through the fuel cell low. A condenser bypass is a device or an arrangement which makes it possible to conduct part of the mass flow or the coolant around the condenser, instead of guiding it through the condenser. The condenser bypass thus conducts the coolant past the condenser. As a result of this, the thermal mass of the circulating coolant in the circuit is reduced and no unnecessary discharge of heat to the surroundings occurs during the starting process.

The system 10 for operating a fuel cell with a two-phase cooling system offers efficient cooling, improved performance and a longer service life of the fuel cell 12. It enables reliable operation even in the case of extreme temperatures and ensures stable and effective energy generation.

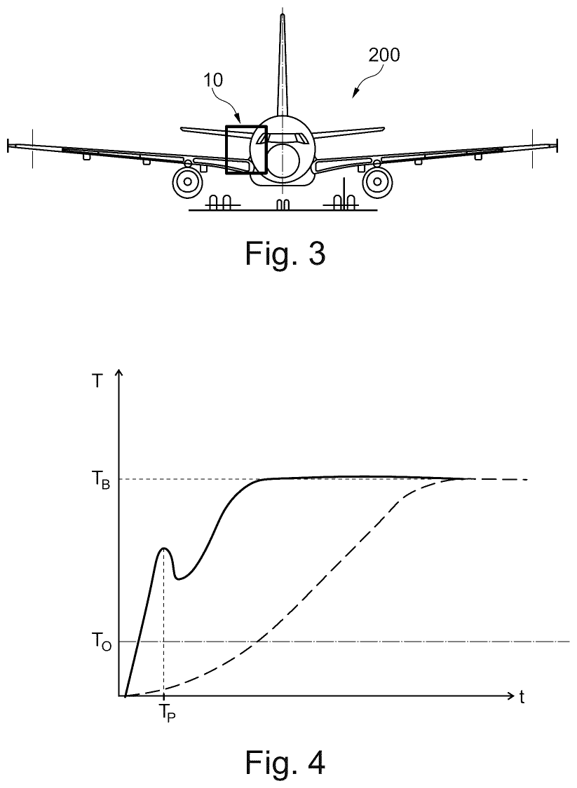

FIG. 3 shows an aircraft 200 which is equipped with a system 10 which was developed for the operation of a fuel cell. The system 10 operates in combination with a fuel cell in order to enable efficient energy generation.

In addition to the cooling system 10 and the pump 20, the system 10 also contains a coolant circuit 16. This coolant circuit 16 enables a continuous flow of the coolant through the system in order to ensure a constant cooling of the fuel cell. The coolant circuit plays a vital role in maintaining the optimum operating temperature of the fuel cell, and can be started with the described method even at temperatures below 0° Celsius.

FIG. 4 shows in each case a graphic representation of two temperature profiles over time. Both graphs begin below 0° Celsius, T₀, and approach the operating temperature T_{B}. It is clearly apparent that the left-hand graph (continuous line) reaches the operating temperature T_{B} quicker than the right-hand graph (dashed line). This is due to the fact that the pump is only activated after a defined period of time t_{P} and the described effects come about. In contrast, the right-hand graph which represents a profile in which the pump is activated right at the start is significantly flatter at the start and the operating temperature T_{B} is reached later relative to this. The described method thus makes it possible to speed up the starting process of the fuel cell at temperatures below freezing point.

It should additionally be pointed out that “comprising” or “having” does not rule out any other elements or steps and “one” or “a” does not rule out a plurality. It should furthermore be pointed out that features or steps which have been described with reference to one of the above example embodiments can also be used in combination with other features or steps of other example embodiments described above. Reference signs in the claims should not be regarded as a restriction.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 System
12 Fuel cell
14 Accumulator
16 Coolant circuit
18 Heat exchanger
20 Pump
100 Method for starting a fuel cell at temperatures below 0° 102 Starting the fuel cell
104 Activating the pump after a defined period of time
200 Aircraft
T₀ Freezing point of water
T_{B} Operating temperature
t_{P} Defined period of time

1. A method for starting a fuel cell at temperatures below 0° Celsius with a two-phase cooling system, the two-phase cooling system comprising a pump for conveying a coolant present in the two-phase cooling system, wherein the coolant is present in the two-phase cooling system at least partially in a gas phase, the method comprising:
starting the fuel cell; and
activating the pump after a defined period of time, whereby the coolant is present substantially in the gas phase within the fuel cell during the defined period of time.

2. The method of claim 1, whereby, 100% of the coolant is present in the gas phase in the fuel cell in starting the fuel cell.

3. The method of claim 1, whereby the defined period of time is at least 60 seconds, or at least 30 seconds, or at least 20 seconds.

4. The method of claim 1, wherein the coolant comprises methanol and/or ethanol.

5. The method of claim 1, whereby the pump operates intermittently in order to keep a thermal mass of a mass flow of the coolant in the fuel cell low.

6. A system for starting a fuel cell at temperatures below 0° Celsius with a two-phase cooling system, wherein the system is configured to perform the method of claim 1, the system comprising:
at least one fuel cell;
a pump;
a coolant circuit;
wherein the coolant circuit is configured to cool the fuel cell by two-phase cooling, and
wherein the pump is configured to be activatable after a defined period of time.

7. The system of claim 5, whereby comprising a condenser bypass to keep a thermal mass of a mass flow to and/or from a condenser low.

8. An aircraft comprising the system of claim 6.
